(19) United States
(12) Patent Application Publication
(10) Pub. No.: US 2002/0027631 A1
(43) Pub. Date: Mar. 7, 2002

(54) Method of fabricating liquid crystal display device, and liquid crystal display device

(75) Inventors: Yoshimasa Saitoh, Kanagawa (JP); Hisanori Tsuboi, Kanagawa (JP)

Correspondence Address: David R. Metzger, SONNENSCHEIN NATH & ROSENTHAL, Wacker Drive Station, Sears Tower, P.O. Box #061080, Chicago, IL, 60606-1080, US

(73) Assignee: SONY CORPORATION

(21) Appl. No.: 09/961,022

(22) Filed: Sep. 21, 2001

Related U.S. Application Data
(62) Division of application No. 09/496,656, filed on Feb. 3, 2000.

(30) Foreign Application Priority Data
Feb. 8, 1999 (JP) P11-030194

(51) Int. Cl. G02F 1/1337

(52) U.S. Cl. 349/124

(57) ABSTRACT

Exposure to polarized UV rays in liquid crystal display device fabrication realizes well-controlled liquid crystal orientation and stable and uniform pre-tilt angle expression in the devices fabricated. A UV-reactive film for liquid crystal orientation is formed on at least one transparent substrate for a liquid crystal cell, then polarized UV rays are applied to the film on the substrate that is aligned parallel to a reference plane, for controlled liquid crystal orientation, and the substrate having thereon the exposed film is rotated on the reference plane and is thereafter again exposed to polarized UV rays for pre-tilt angle expression.

### BACKGROUND OF THE INVENTION

1. Field of the Invention

The present invention relates to a method of fabricating a liquid crystal display device that includes a step of liquid crystal orientation and pre-tilt angle formation through exposure to polarized Uv rays, and to a liquid crystal display device.

2. Description of the Related Art

The problems confronting the mechanical rubbing method for liquid crystal orientation in fabrication of liquid crystal display devices are that the devices being fabricated are contaminated with dust formed during the rubbing step, the transparent substrates with TFT cells mounted thereon are electrostatically damaged by the frictional force applied thereto, and after all the production yield of the devices is lowered.

Therefore, an optical orientation control technique capable of inducing non-contact liquid crystal orientation is being specifically noticed in place of the mechanical rubbing method (Japanese Patent Laid-Open No. 318942/1995, etc.). This comprises applying polarized UV rays to an organic film for liquid crystal orientation formed on a transparent substrate so as to produce chemical change in the molecules constituting the film in accordance with the polarization of the UV rays, thereby realizing the directional control and the pre-tilt angle of the film for the intended liquid crystal orientation. The technique is free from the problems with the mechanical rubbing method troubled by contamination with dust and by electrostatic damage of TFT cells-mounted substrates, and is therefore effective for increasing the production yield. According to the technique, in addition, it is possible to apply the polarized UV rays to only a limited fine area of the organic film for liquid crystal orientation, and it is easy to attain selective liquid crystal orientation in a desired fine area in accordance with the exposed fine area of the film. This makes it possible to improve the angle of visibility of the devices fabricated through partitioned orientation of one organic film for liquid crystal orientation.

However, the technique of employing such polarized UV ray exposure for liquid crystal orientation is problematic in that it is difficult to strictly control the intended liquid crystal orientation and to stably express the intended pre-tilt angle, when compared with the mechanical rubbing method. Therefore, the display devices with liquid crystal cells processed for liquid crystal orientation through polarized UV ray exposure are still confronted with the problems that the cells are unevenly oriented and the display quality including transmittance and contrast of the devices fabricated is poor. Those problems with the optical orientation control technique are the serious bar to mass production of liquid crystal display devices according to that technique.

### SUMMARY OF THE INVENTION

The present invention is to solve the problems with the related art noted above, and its object is to provide a technique of liquid crystal orientation through polarized UV ray exposure capable of realizing good liquid crystal orientation control and stable and uniform pre-tilt angle formation.

We, the present inventors have found that, for fabricating a liquid crystal display device, when the film for liquid crystal orientation disposed on a transparent substrate is exposed to polarized UV rays in such a manner that polarized UV rays are first applied to the film so as to specifically control the intended liquid crystal orientation, next the transparent substrate is rotated, and thereafter polarized UV rays are again applied to the film so as to specifically control the pre-tilt angle of the liquid crystal in the device being fabricated, then uniform and stable liquid crystal orientation and pre-tilt angle formation can be realized. On the basis of this finding, we have completed the present invention.

Specifically, the invention provides a method of fabricating a liquid crystal display device with liquid crystal sandwiched between a pair of transparent substrates and with a film for liquid crystal orientation formed on at least one transparent substrate adjacent to the liquid crystal, the method comprising;

(a) a step of forming a UV-reactive film for liquid crystal orientation on at least one transparent substrate,

(b) a step of applying polarized UV rays to the film on the substrate that is aligned parallel to a reference plane for controlled liquid crystal orientation, and

(c) a step of rotating, on the reference plane, the substrate having thereon the film exposed to the polarized UV rays in the step (b), in such a manner that the liquid crystal orientation having been controlled in a predetermined direction in the step (b) may turn in a direction that differs from its predetermined direction, followed by again applying polarized UV rays to the film for pre-tilt angle expression.

The invention also provides the liquid crystal display device fabricated in the method.

### BRIEF DESCRIPTION OF THE DRAWINGS

FIG. 1 is a schematic view showing the outline of a UV exposure system.

FIG. 2 is a schematic view showing the polarized UV exposure process in Example 1.

FIG. 3 is a schematic view showing the polarized UV exposure process in Example 2.

FIG. 4 is a schematic view showing the polarized UV exposure process in Example 3.

FIG. 5 is a graph showing the spectral pattern of polarized UV rays to be applied to transparent substrates.

FIG. 6 is a graph showing the voltage-transmittance profile of the liquid crystal panels of Examples 1, 2 and 3.

### DESCRIPTION OF THE PREFERRED EMBODIMENTS

The liquid crystal display device to be fabricated according to the method of the invention basically comprises, like ordinary TN liquid crystal display devices, a pair of transparent substrates having liquid crystal therebetween, and a film for liquid crystal orientation formed on at least one transparent substrate adjacent to liquid crystal. The method of fabricating the liquid crystal display device comprises the following steps (a) to (c) for liquid crystal orientation.

Step (a):

A UV-reactive film for liquid crystal orientation is first formed on one or both surfaces of a pair of transparent substrates.

The transparent substrate may be of glass, like in ordinary TN liquid crystal cells. For example, preferably employed herein are transparent glass substrates for ordinary high-temperature poly-Si TFT cells having a diagonal distance of at least 0.55 inches (1.397 cm) and having at least 113,000 dot pixels; and transparent glass substrates for ordinary low-temperature poly-Si TFT cells having a diagonal distance of at least 2.5 inches (6.25 cm) and having at least 180,000 dot pixels.

The material for the UV-reactive film for liquid crystal orientation shall have the property of realizing liquid crystal orientation in the direction vertical to the polarization direction of polarized UV rays to be applied to the film. For example, employable herein are polyamic acid-type polymers for polyimide-type materials for optical orientation, such as those disclosed in U.S. Pat. No. 5,731,405.

The thickness of the film for liquid crystal orientation may fall generally between 0.02 and 0.08 μm.

The method of forming the film for liquid crystal orientation may be suitably selected, depending on the material for the film employed.

Step (b):

Next, for controlled liquid crystal orientation, polarized UV rays are applied to the film for liquid crystal orientation having been formed on the transparent substrate in the previous step, with the substrate being aligned in parallel to a reference plane (first UV exposure). To align the transparent substrate in parallel to a reference plane, for example, the substrate may be put on a flat steel board (to be the reference plane).

The polarized UV rays may be those having passed through a polarizing filter. The polarizing filter may be any ordinary one capable of selectively transmitting rays only that run in a predetermined direction.

As the light source for the polarized UV rays, preferred is a non-electrode discharge-type, high-power UV lamp having a long life and having high uniformity (with little illuminance fluctuation).

The angle of the polarized UV rays to the film (the elevation angle thereof to the reference plane) in the first UV exposure step preferably falls between 50 and 90 degrees, so as not to lower the contrast of the device fabricated. More preferably, the angle is 80˜90 degrees.

Step (c):

Next, the transparent substrate with the film having been exposed to polarized UV rays in the first UV exposure step (b) is rotated on the reference plane in such a manner that the liquid crystal orientation having been controlled in a predetermined direction in the step (b) may turn in a direction that differs from its predetermined direction. In that condition, the film on the thus-rotated substrate is again exposed to polarized UV rays (second UV exposure) for pre-tilt angle expression. As the case may be, turning the substrate may be effected by moving the light source for the polarized UV ray around the substrate.

The reason why the substrate is rotated in that manner is because, if not, a stable pre-tilt angle could not be induced. The angle of substrate rotation preferably falls between 45 and 90 degrees, and is more preferably 90 degrees.

The angle of the polarized UV rays to the film (the elevation angle thereof to the reference plane) in the second UV exposure step preferably falls between 50 and 80 degrees. If the angle oversteps the range, the pre-tilt angle will be small and could not be stabilized.

The ratio of the dose of the first UV exposure in the step (b) to that of the second UV exposure in the step (C) preferably falls between 100/1 and 1/1, more preferably between 5/1 and 3/1. If the dose of the second UV exposure is relatively larger than the defined range, the pre-tilt angle will be small.

The transparent substrate having been thus processed for liquid crystal orientation in the steps (a) to (c) is fabricated in an ordinary manner to construct a liquid crystal cell, and this is then assembled with a liquid crystal driving unit into a liquid crystal display device according to an ordinary process of fabricating conventional TN liquid crystal display devices. The liquid crystal display device thus fabricated realizes stable and constant liquid crystal orientation and possesses a stable pre-tilt angle. Therefore, its production yield is high, and its electro-optical properties are good.

### EXAMPLES

The invention is described concretely with reference to the following Examples.

### Example 1

A transparent glass substrate having a diagonal distance of 0.7 inches was integrated with a polysilicon TFT cell, a black matrix of, for example, a metal (OCB), and a color filter of, for example, a negative photoresist (OCCF), all formed thereon according to a dry-etching technique. The substrate had 1,557,000 dots for full-color display corresponding to SVGA with a numerical aperture of being 10%, and the size of one dot was 5.6 μm in length×1.7 μm in width. As the counter substrate to this, used was a glass substrate with a non-patterned ITO transparent electrode formed thereon.

Next, a polyimide-type chemical for liquid crystal orientation (see U.S. Pat. No. 5,731,405) was applied to the substrates in a known method, pre-dried at 80° C. for 30 minutes, and then finally dried at 190° C. for 60 minutes to form a film for liquid crystal orientation on the substrates.

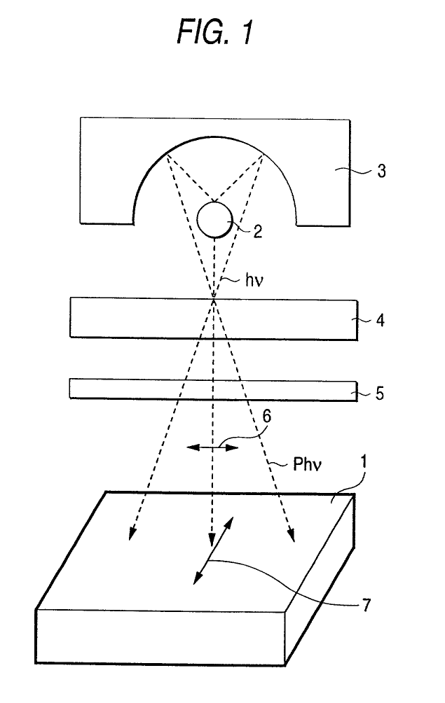

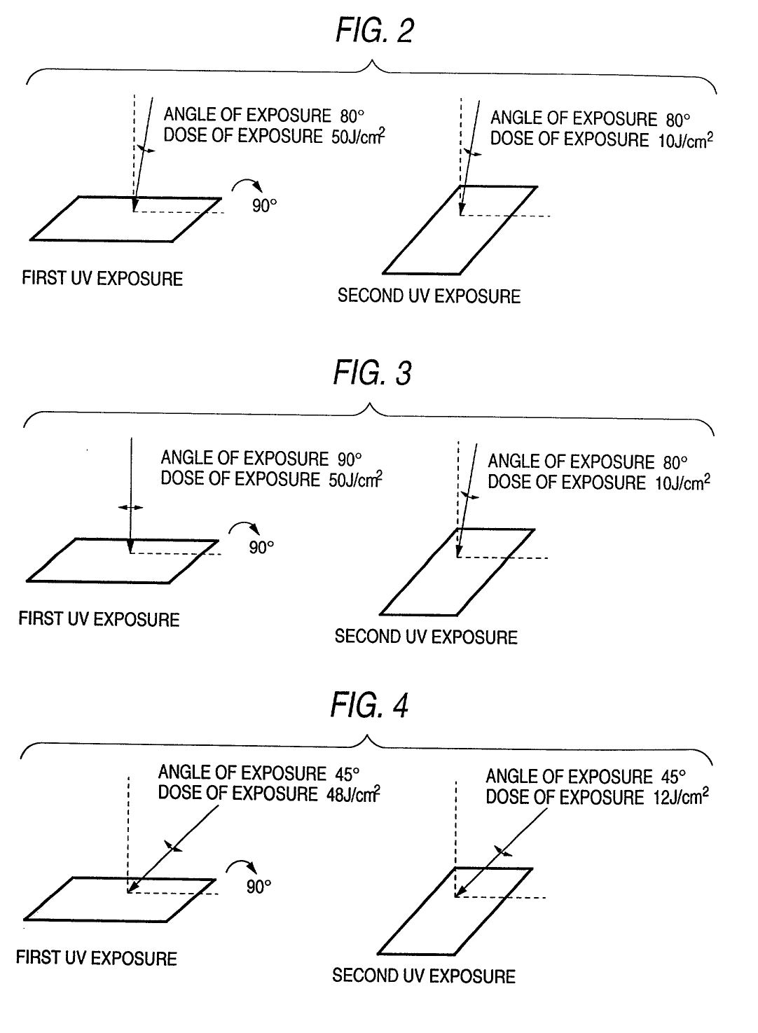

Next, the substrates were processed for liquid crystal orientation by the use of a UV exposure system (Fusion's non-electrode lamp, “H” Bulb), as in FIG. 1. Precisely, UV rays hv from the lamp unit 3 equipped with a light bulb 2 were passed through the polarizing unit 4 and through the filter 5 (this cuts off rays having a wavelength of 300 nm or shorter) to give polarized UV rays Phv (for which 6 indicates the polarization axis), and the polarized UV rays Phv were applied to the surface of the film for liquid crystal orientation formed on the substrate 1 in two stages, as in FIG. 2. The total dose of uv exposure was 60 J/cm². The spectral pattern of the polarized UV rays having passed through the filter 5 is shown in FIG. 5. 7 indicates the polarization axis in second UV exposure.

Condition for First UV Exposure:

Angle of exposure (elevation): 80°

Dose of exposure: 50 J/cm²

UV intensity: 100±10 mW/cm²

Condition for Second UV Exposure:

Angle of substrate rotation: 90°

Angle of exposure (elevation): 80°

Dose of exposure: 10 J/cm²

UV intensity: 100±10 mW/cm²

Next, the counter substrate was also exposed in the same manner as above. In this case, however, the polarization of UV rays to be applied to the two substrates was so controlled that the polarization axis for the counter substrate was perpendicular to that for the substrate 1. This is in order that the orientation of the liquid crystal molecules by the substrate 1 could be perpendicular to that by the counter substrate.

The pair of transparent substrates having been thus processed through polarized UV exposure for controlled liquid crystal orientation were attached to each other via a gap of 3.5 μm therebetween in such a manner that the liquid crystal orientation by them could differ by 90 degrees, and TN liquid crystal was injected into the gap to construct a TN liquid crystal cell. The polarizing plate was aligned in the manner of normally-white alignment where the orientation axis was perpendicular to the polarization axis.

With the liquid crystal cell, produced was a TN liquid crystal panel in an ordinary manner.

### Example 2

Another TN liquid crystal panel was produced in the same manner as in Example 1, except that the angle of first UV exposure (elevation) was 90 degrees (in the direction normal to the substrate), as in FIG. 3.

### Example 3

Still another TN liquid crystal panel was produced in the same manner as in Example 1, except that the angle of first UV exposure (elevation) was 45 degrees and the dose thereof was 48 J/cm², and that the angle of second UV exposure (elevation) was 45 degrees and the dose thereof was 12 J/cm², as in FIG. 4.

Evaluation of Panels:

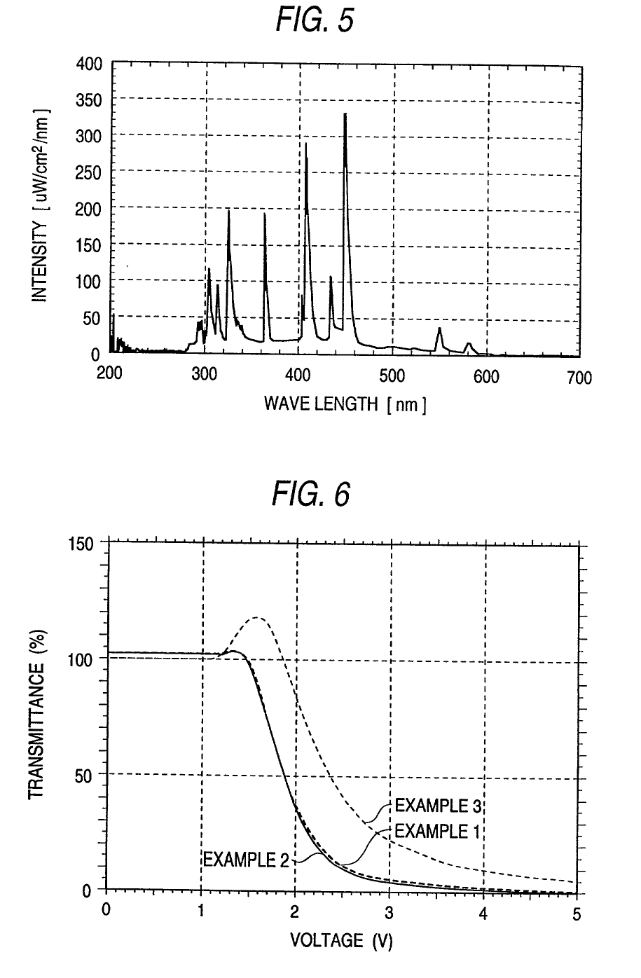

The TN liquid crystal display panels produced in Examples 1 to 3 were tested in an ordinary manner for the pre-tilt angle and the contrast ratio. The data obtained is given in Table 1 below. The voltage-transmittance profile of the TN liquid crystal panels of these Examples is shown in FIG. 6.

TABLE 1

| | Example 1 | Example 2 | Example 3 |
|---|---|---|---|
| Contrast Ratio | 138 | 141 | 38 |
| Pre-tilt Angle | 3.5° | 3.9° | 1.5° |

As in Table 1, the TN liquid crystal panel of Example 1 was confirmed to have expressed a pre-tilt angle of 3.5 degrees, and had a contrast ratio over 100; and the TN liquid crystal panel of Example 2 had a pre-tilt angle of 3.9 degrees and a contrast ratio over 100. The two panels both had good orientation characteristics.

Of the TN liquid crystal panel of Example 3, for which the angle of second UV exposure (elevation) to control the pre-tilt angle was 45 degrees, both the pre-tilt angle (1.5 degrees) and the contrast ratio (38) were smaller than those of the TN liquid crystal panels of Examples 1 and 2. In addition, the voltage-transmittance profile of the panel of Example 3 was inferior to that of the panels of Examples 1 and 2. Therefore, it is desirable that at least the angle of second UV exposure (elevation) is larger than 45 degrees.

According to the method of the invention that comprises a series of specific polarized UV exposure steps but not an ordinary mechanical rubbing step, obtained is a liquid crystal display device in which the liquid crystal molecules are well oriented in the controlled direction to express a stable and uniform pre-tilt angle. Therefore, the liquid crystal display device fabricated in the invention has good electro-optical properties.

What is claimed is:

1. A method of fabricating a liquid crystal display device with liquid crystal sandwiched between a pair of transparent substrates and with a film for liquid crystal orientation formed on at least one transparent substrate adjacent to the liquid crystal, the method comprising;
a step of forming a UV-reactive film for liquid crystal orientation on at least one transparent substrate,
a step of applying first polarized UV rays to the film,
a step of rotating the substrate on a reference plane, and
a step of applying second polarized UV rays to the film.

2. A method of fabricating a liquid crystal display device with liquid crystal sandwiched between a pair of transparent substrates and with a film for liquid crystal orientation formed on at least one transparent substrate adjacent to the liquid crystal, the method comprising;
a step of forming a UV-reactive film for liquid crystal orientation on at least one transparent substrate,
a step of applying first polarized UV rays to the film on the substrate that is aligned parallel to a reference plane for controlled liquid crystal orientation,
a step of rotating, on the reference plane, the substrate having thereon the film exposed to the first polarized UV rays, in such a manner that the liquid crystal orientation having been controlled in a predetermined direction in the first polarized UV ray exposure step may turn in a direction that differs from its predetermined direction, and
a step of applying second polarized UV rays to the film for pre-tilt angle expression.

3. The method of fabricating a liquid crystal display device as claimed in claim 1 or 2, wherein the rotation angle in the step of rotating the substrate is 90 degrees.

4. The method of fabricating a liquid crystal display device as claimed in any one of claims 1 to 3, wherein the angle of the first UV exposure falls between 50 and 90 degrees relative to the reference plane.

5. The method of fabricating a liquid crystal display device as claimed in any one of claims 1 to 4, wherein the angle of the second UV exposure falls between 50 and 80 degrees relative to the reference plane.

6. The method of fabricating a liquid crystal display device as claimed in any one of claims 1 to 5, wherein the ratio of the dose of the first UV exposure to that of the second UV exposure falls between 100/1 and 1/1.

7. The method of fabricating a liquid crystal display device as claimed in any one of claims 1 to 6, wherein the light source of the polarized UV rays is a non-electrode discharge-type UV lamp.

8. A liquid crystal display device comprising a pair of transparent substrates being aligned via a predetermined distance therebetween with at least one of them having thereon a film for liquid crystal orientation, and a liquid crystal put in the distance between the substrates, wherein;
the film is a UV-reactive film, and is exposed to first polarized UV rays while being on the substrate aligned parallel to a reference plane, and next to second polarized UV rays after the substrate is rotated on the reference plane.

9. The liquid crystal display device as claimed in claim 8, wherein the substrate rotation angle is 90 degree.

10. The liquid crystal display device as claimed in claim 8 or 9, wherein the angle of the first UV exposure falls between 50 and 90 degrees relative to the reference plane.

11. The liquid crystal display device as claimed in any one of claims 8 to 10, wherein the angle of the second UV exposure falls between 50 and 80 degrees relative to the reference plane.

12. The liquid crystal display device as claimed in any one of claims 8 to 11, wherein the ratio of the dose of the first UV exposure to that of the second UV exposure falls between 100/1 and 1/1.

13. The liquid crystal display device as claimed in any one of claims 8 to 12, wherein the light source of the polarized UV rays is a non-electrode discharge-type UV lamp.
